(19) United States
(12) Patent Application Publication
(10) Pub. No.: US 2020/0411822 A1
(43) Pub. Date: Dec. 31, 2020

(54) BATTERY MODULE AND TRACTION BATTERY

(71) Applicant: MAHLE International GmbH, Stuttgart (DE)

(72) Inventors: Ingo Haeusler, Esslingen (DE); Ruediger Knauss, Kernen i. R. (DE)

(21) Appl. No.: 16/914,345

(22) Filed: Jun. 27, 2020

(30) Foreign Application Priority Data
Jun. 28, 2019 (DE) 10 2019 209 524.0
Sep. 23, 2019 (DE) 10 2019 214 452.7

(51) Int. Cl. H01M 2/10; B60K 1/04; B60L 50/60; B60L 58/26; H01M 10/613; H01M 10/625; H01M 2/02

(52) U.S. Cl. CPC H01M 2/1083; H01M 2/1077; B60K 1/04; B60L 50/66; B60K 2001/0405; H01M 10/613; H01M 10/625; H01M 2/0237; H01M 2220/20; B60L 58/26

(57) ABSTRACT

A battery module for a traction battery, in particular for a battery electric vehicle includes a battery cell stack and a module housing. The module housing has a first housing part and a second housing part and surrounds an interior in which the battery cell stack is arranged. The battery cell stack is formed from several battery cells, which are arranged adjacent to one another in a stacking direction. The module housing can be flowed through in particular directly by a coolant, such that the battery cells in the interior come directly in contact with the coolant. The battery module has a locking device, which secures the battery cell stack within the interior in a form-fitting manner at least to one of the housing parts, in particular to the first housing part. The disclosure also relates to a traction battery for a battery electric vehicle with the battery module.

### CROSS REFERENCE TO RELATED APPLICATIONS

This application claims priority to German patent applications DE 10 2019 209 524.0, filed on Jun. 28, 2019 and DE 10 2019 214 452.7, filed Sep. 23, 2019, the entire contents of which are incorporated herein by reference.

### TECHNICAL FIELD

The disclosure relates to a battery module for a traction battery, in particular for a battery electric vehicle. The disclosure also relates to a traction battery for the battery electric vehicle with the battery module.

### BACKGROUND

Traction batteries with battery modules for two-track battery electric vehicles or BEVs (BEV: battery electric vehicle) are already known from the related art. A battery module usually includes a battery cell stack and a module housing, wherein the battery cell stack has several battery cells stacked against one an-other and is arranged within the module housing. In operation, waste heat is generated in the battery cells, which must be discharged toward the exterior. For this, the battery cells can be flowed around directly by the liquid coolant within the module housing and can thereby be integrated directly into a cooling circuit. The cooling circuit includes a pump for conveying coolant and further components—such as for example a cooler, a chiller, valves or a filter. The module housing is acted upon here with the delivery pressure of the pump, so that large areas of the module housing can bulge, despite reinforcement structures which are provided. Through the bulging, unwanted bypass flows of the coolant can occur in the module housing, so that some of the battery cells can no longer be cooled or no longer cooled sufficiently. Furthermore, in an extreme case such a bulging can cause a mechanical damage to the module housing.

From DE 10 2018 215 036 A1 a module housing is known for example, in which the bulging is reduced by tie rods. Here, the tie rods connect opposite housing parts of the module housing with each other through the battery cell stack. Thereby, the tie rods achieve a further reinforcement of the module housing and reduce its bulging. Disadvantageously, large areas of the module housing also remain not attached here and can bulge through the delivery pressure of the pump. As the tie rods must be freely accessible for mounting and dismantling, an introducing of further tie rods of this type is, however, very laborious.

### SUMMARY

It is an object of the disclosure to provide for a battery module of the generic type an improved or at least alternative embodiment, in which the described disadvantages are overcome. In particular, further connection points are to be produced between the battery cell stack and parts of the module housing which are inaccessible in the mounted state. Mounting and dismantling of the battery cell stack in the module housing are not to be unnecessarily complicated here. Furthermore, the overall height of the battery module is not to be appreciably increased. A further object of the disclosure is to provide a corresponding traction battery.

The object is achieved by a battery module for a traction battery, in particular for a battery electric vehicle and a traction battery for a battery electric vehicle as described herein.

A battery module is provided for a traction battery, in particular for a battery electric vehicle and has a battery cell stack and a module housing. The module housing has a first housing part and a second housing part and surrounds an interior in which the battery cell stack is arranged. The battery cell stack is therefore received in the module housing and is protected toward the exterior by the latter on all sides. The battery cell stack is formed of several battery cells which are arranged adjacent to one another in a stacking direction. The module housing can be flowed through directly by a fluid coolant, in particular by a dielectric fluid, such that the battery cells in the interior of the module housing enter directly in contact with the coolant or respectively are acted upon directly by the coolant. According to an aspect of the disclosure, the battery module has a locking device which secures the battery cell stack in a form-fitting manner within the interior on at least one of the housing parts, in particular on the first housing part.

Through the locking device, the battery cell stack is fixed in a form-fitting and detachable manner within the module housing on the first and/or second housing part, whereby the first and/or second housing part is reinforced by the stable structure of the battery cell stack. Thereby, the stability and the rigidity of the module housing can be increased and an unwanted bulging of the module housing can be advantageously prevented. In particular, mechanical damage to the module, occurring in an extreme case, can be effectively counteracted. Furthermore, the module housing can be flowed through along paths which are provided, and the battery cells of the battery cell stack can be cooled efficiently.

The first housing part is, for example, a housing upper shell, which is open on one side. The housing upper shell is provided for fastening to the vehicle floor of the battery electric vehicle, wherein it is expediently mounted so as to be open downwards. The second housing part is, for example, a plate-shaped housing cover, which closes the open side of the housing upper shell. The housing cover is expediently detachably connected to the housing upper shell, for example is screwed thereto. The first housing part and the second housing part delimit the interior toward the exterior, in which interior the battery cell stack is arranged. The interior is configured to be flowed around directly by the fluid coolant, in particular by a dielectric fluid, and the interior is expediently sealed toward the exterior.

The battery cell stack includes several battery cells which are arranged adjacent to one another in a stacking direction. The battery cell stack has two stack ends which lie opposite to one another in the stacking direction. At the two stack ends, respectively, a clamping plate can be arranged, and the battery cells can be braced between the two clamping plates in the stacking direction. For this, at least one clamping band can be provided, which then rests against the two clamping plates. The respective clamping band wraps around the battery cell stack and can be additionally integrated into the connection between the second housing part and the battery cell stack. The battery cell stack can be secured on the second housing part detachably—for example with the locking device—or undetachably and can be mounted together therewith on the first housing part.

For example, the battery cell stack can be detachably secured in a form-fitting manner within the interior with the locking device on the first housing part and on the second housing part. Alternatively, the battery cell stack can be secured with the locking device detachably in a form-fitting manner on the first housing part and undetachably with the second housing part, typically by an adhesive connection. The term “undetachably” is to be understood to mean that the connection cannot be detached without appreciable damage of at least one of the two connection partners. For example, on separating the adhesive connection, the battery cell stack and/or the second housing part can become unusable. In both the alternatives mentioned here, the second housing part is reinforced by the stable structure of the battery cell stack, such that the unwanted bulging of the second housing part is prevented. Alternatively, the battery cell stack can be detachably secured in a form-fitting manner within the interior with the locking device only on the second housing part.

According to an aspect of the disclosure, the locking device has at least one slider. The respective slider is held here within the battery cell stack and is displaceable between a locking position and an unlocking position. The respective slider then in the locking position is in engagement with a latch structure formed on one housing part, in particular on the first housing part, and in the unlocking position is free of the respective latch structure. When the slider is in the locking position, then at least one additional connection site is produced between the battery cell stack and the one housing part, in particular the first housing part. The slider can be held within an intermediate plate or respectively can be received in the intermediate place and displaceable within the latter. The intermediate plate is arranged here in the battery cell stack between two adjacent battery cells and is braced in the battery cell stack together with the battery cells. Typically, the intermediate plate is arranged spaced apart from the stack ends of the battery cell stack which lie opposite in the stacking direction. In particular, the intermediate plate can be arranged centrally in the battery cell stack with respect to the stacking direction.

According to an aspect of the disclosure, the respective slider can be displaceable between the locking position and the unlocking position transversely to the stacking direction in the widthwise direction. Here, the respective slider and the respective latch structure can be brought into engagement with one another in such a way that tractive forces running in tractive force direction transversely to the stacking direction and transversely to the widthwise direction can be transferred between the one housing part, in particular the first housing part, and the battery cell stack. The respective slider can cooperate with a return spring, which drives the respective slider into the unlocking position. The return spring can be held here in the above-mentioned intermediate plate or supported on the latter. The stacking direction, the widthwise direction and the tractive force direction are aligned here with respect to one another, respectively perpendicularly, and respectively along the longitudinal axis, the width axis and the vertical axis of the battery cell stack. When the battery module is mounted in the battery electric vehicle, the stacking direction and the widthwise direction lie in the XY plane of the vehicle, and the tractive force direction corresponds to the Z direction of the vehicle.

For displacing the slider into the locking position, the locking device can have at least one securing element which is displaceable between a securing position and a releasing position. The respective securing element then cooperates with at least one such slider. When the respective securing element is displaced into its securing position, the respective slider is then displaced by the securing element into the locking position and is secured in the latter. When the securing element is displaced into the securing position, the respective slider is no longer displaceable into the unlocking position and is secured in its locking position. When the securing element is displaced into the releasing position, then the respective slider can then be displaced for example by the above-mentioned return spring into the unlocking position.

According to an aspect of the disclosure, the securing element can be displaceable between the securing position and the releasing position transversely to the stacking direction in tractive force direction. The respective securing element cooperates here with at least one such slider in such a way that the respective slider is displaceable into the locking position transversely to the stacking direction in widthwise direction. When the battery cell stack is arranged in the first housing part and is to be secured with the locking device on the first housing part in a form-fitting manner, the slider is arranged facing the latch structure of the first housing part and is situated between the first housing part and the battery cell stack. Therefore, the respective slider is inaccessible from the exterior and is actuated by the securing element. Here, the securing element can be accessible from a side of the battery cell stack facing away from the latch structure or respectively from a side of the battery cell stack facing the second housing part or respectively from an outer side of the second housing part facing away from the first housing part. The securing element is thereby displaceable from the exterior into the securing position or into the releasing position and can actuate the slider which is inaccessible from the exterior. Thereby, the mounting and the dismantling of the battery cell stack in the module housing can be distinctly simplified.

The battery cell stack can be detachably secured in a form-fitting manner with the locking device on the first housing part and on the second housing part. The locking device then has at least one slider which in its locking position is in engagement with the latch structure on the first housing part and in its unlocking position is free of this latch structure. In addition, the locking device has at least one slider which in its locking position is in engagement with the latch structure on the second housing part and in its unlocking position is free of this latch structure. The respective sliders can then be actuatable by a shared securing element or by separate securing elements.

According to an aspect of the disclosure, for locking the battery cell stack with the one housing part, in particular with the first housing part, two sliders which are displaceable in a widthwise direction and one securing element which is displaceable in a tractive force direction can be provided. Here, the two sliders move oppositely and cooperate with the same securing element. When the securing element is displaced into the securing position, the two sliders are displaced into their respective locking position and are secured in the latter. For the form-fitting securing of the battery cell stack on the two housing parts, four sliders which are displaceable in widthwise direction and one securing element which is displaceable in tractive force direction can be provided. Two sliders are then provided for locking with the latch structure formed on the first housing part, and two sliders are then provided for locking with the latch structure formed on the second housing part. Here, the sliders move oppositely in pairs and cooperate with the same securing element. When the securing element is displaced into the securing position, the four sliders are displaced into their respective locking position and are secured in the latter.

In a further development of the securing element, provision is made that the respective securing element in the securing position connects the first housing part transversely to the stacking direction in tractive force direction with the second housing part. For example, the securing element can be a tie rod with a head and with a shaft adjoining thereon in one piece. The head can rest here on an outer side of the second housing part facing away from the first housing part, and the shaft can engage in a form-fitting manner into the first housing part, penetrating the interior. The tie rod thereby serves for the transfer of the tractive forces between the first housing part and the second housing part. When an intermediate plate is provided, as described above, the shaft of the tie rod can penetrate the intermediate plate and be brought into engagement with the first housing part. When the tie rod is in form-fitting engagement with the first housing part, the securing element is situated in the securing position and the respective slider cannot be displaced from its locking position. The form-fitting engagement typically concerns a threaded connection between the shaft and the first housing part. With a correspondingly selected tightening torque, the tie rod which is screwed into the first housing part can be secured sufficiently against an unwanted loosening. Nevertheless, the module housing can be opened easily, for example for maintenance purposes and repairs of the battery module.

In summary, in the battery module according to an aspect of the disclosure the module housing can be additionally reinforced and thereby a possible bulging of the module housing can be effectively counteracted. Thereby, the stability against the internal pressure in the module housing can be improved. In addition, the mounting and the dismantling are facilitated and the accessibility of the battery module in the case of maintenance is improved.

The disclosure also relates to a traction battery for a battery electric vehicle, which has at least one battery module, described above. The traction battery can have, for example, only a single battery module, which then represents the traction battery. Alternatively, the traction battery can have several battery modules, wherein the battery modules with their module housings are accommodated in a shared battery housing. The battery housing can then have a first battery housing part and a second battery housing part, which are secured to one another in a detachable manner. The first battery housing part can be a battery housing upper shell which is open on one side. The battery housing upper shell is provided for fastening to a vehicle underbody of the battery electric vehicle, wherein it is expediently mounted so as to be open downwards. The second battery housing part is, for example, a plate-shaped battery housing cover, which closes the open side of the battery housing upper shell. Within the battery housing, the respective battery modules are then received. The interiors of the respective battery modules can be flowed through directly by the fluid coolant and are expediently sealed towards the exterior. The battery housing cover and the battery housing upper shell are expediently connected to one another detachably, for example are screwed to one another.

Alternatively, the traction battery can have several battery modules, wherein a shared battery housing represents the respective module housings of the battery modules. The battery housing can then have a first battery housing part and a second battery housing part. The first battery housing part then represents all the first housing parts of the battery modules and can be a battery housing upper shell which is open on one side. The battery housing upper shell is then provided for fastening to a vehicle underbody of the battery electric vehicle, wherein this is expediently mounted so as to be open downwards. The second battery housing part is, for example, a plate-shaped battery housing cover, which closes the open side of the battery housing upper shell. Within the battery housing, a shared interior can then be formed for all battery cell stacks of the respective battery modules. It is also conceivable, however, that within the battery housing several interiors, configured to be flowed through independently of each other, are formed for the respective battery cell stacks. Then several plate-shaped battery housing covers can be provided, which are provided for the individual interiors. The respective interiors can be flowed through directly by the fluid coolant and are expediently sealed towards the exterior. The respective battery housing cover and the battery housing upper shell are expediently connected to one another detachably, for example are screwed to one another.

It shall be understood that the features mentioned above and to be explained further below are able to be used not only in the respectively indicated combination, but also in other combinations or in isolation, without departing from the scope of the present disclosure.

### BRIEF DESCRIPTION OF THE DRAWINGS

The disclosure will now be described with reference to the drawings wherein:

FIG. 1 shows a sectional view of a battery module with a released locking device according to an exemplary embodiment of the disclosure;

FIG. 2 shows a sectional view of the battery module shown in FIG. 1 with the locked locking device;

FIG. 3 shows a view of a battery cell stack of the battery module according to an exemplary embodiment of the disclosure; and

FIG. 4 shows a view of the battery cell stack of FIG. 3, which is connected with a second housing part in a non-detachable manner.

### DESCRIPTION OF EXEMPLARY EMBODIMENTS

Exemplary embodiments of the disclosure are illustrated in the drawings and are explained further in the following description, wherein the same reference numbers refer to identical or similar or functionally identical components.

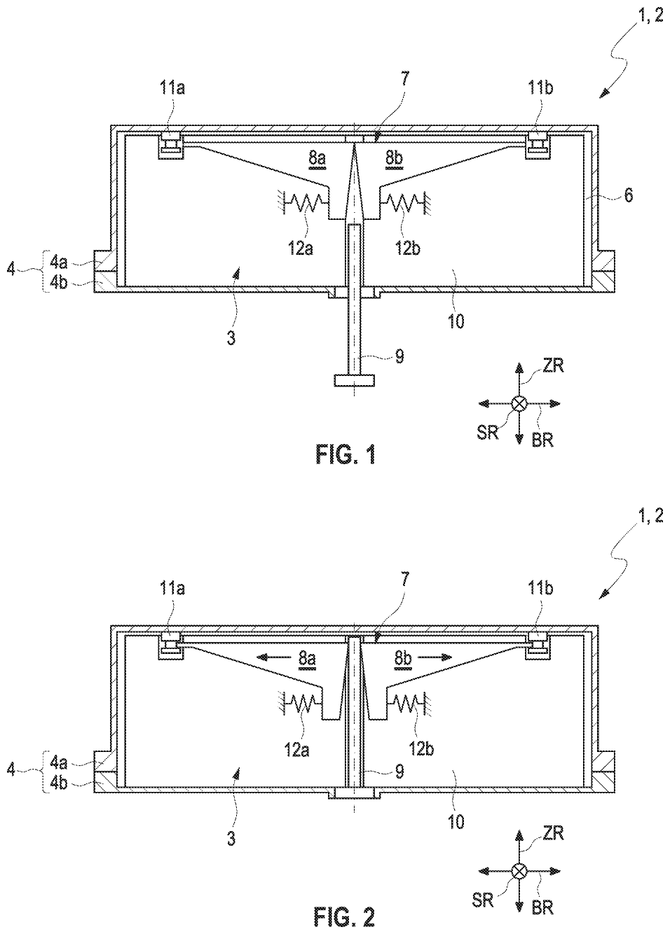

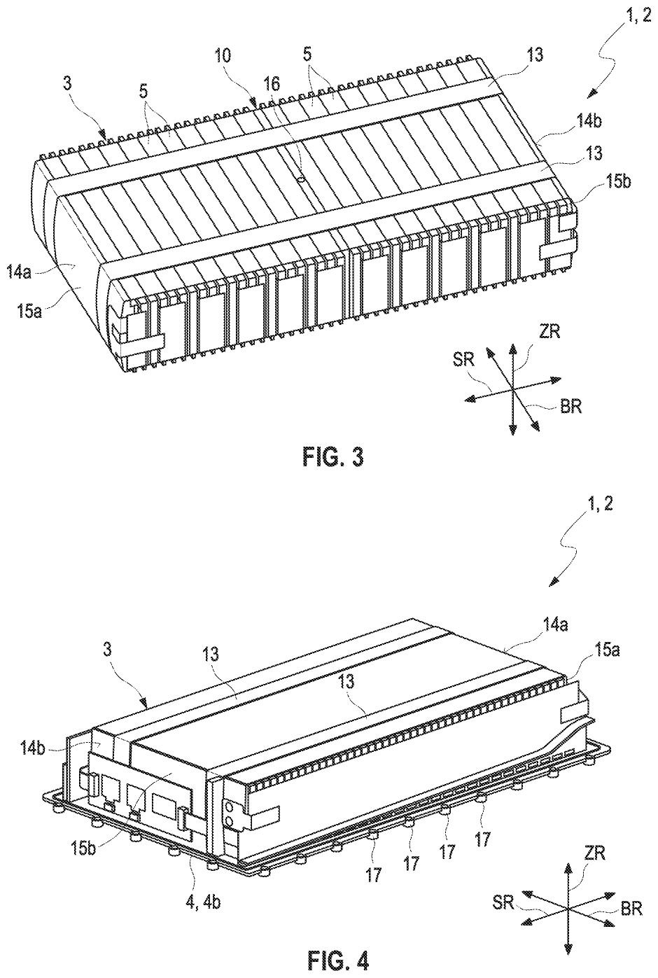

FIG. 1 and FIG. 2 show sectional views of a battery module 1 according to an exemplary embodiment of the disclosure for a traction battery 2 of a battery electric vehicle on a locking device 7. In this exemplary embodiment, the battery module 1 represents the traction battery 2 entirely. The battery module 1 has a battery cell stack 3 and a module housing 4. The battery cell stack 3 is cuboid-shaped and consists of several battery cells 5, as is shown in FIG. 3 and FIG. 4. The battery cells 5 are arranged against one another in stacking direction SR and are braced with one another, wherein the stacking direction SR coincides with a longitudinal axis of the battery cell stack 3. Furthermore, in the battery cell stack 3 a widthwise direction BR and a tractive force direction ZR are defined, which are aligned perpendicularly to the stacking direction SR and to one another.

The module housing 4 has a first housing part 4a and a second housing part 4b, which are screwed to one another. The first housing part 4a here is a housing upper shell which is open on one side, and which is provided for fastening to a vehicle underbody of the battery electric vehicle. The second housing part 4b is a plate-shaped housing cover, which closes the housing upper shell from the open side. When the battery module 1 is mounted on the battery electric vehicle, the stacking direction SR and the width-wise direction BR are arranged in an XY plane of the vehicle, and the tractive force direction ZR corresponds to the Z direction of the vehicle. The module housing 4 surrounds an interior 6, in which the battery cell stack 3 is arranged so as to be able to be flowed around by the fluid coolant. The battery cell stack 3 is secured within the interior 6 on the first housing part 4a detachably in a form-fitting manner and is glued to the second housing part 4b. Thereby, the module housing 4 is reinforced, so that a bulging of the module housing 4 during flowing through by the coolant can be effectively counteracted.

For securing the battery cell stack 3 on the first housing part 4a, the battery module 1 has a locking device 7, which has two sliders 8a and 8b and a securing element 9 cooperating with these. The two sliders 8a and 8b and the securing element 9 are received in an intermediate plate 10, which is arranged between two adjacent battery cells 5 and approximately centrally in the battery cell stack 3, as is shown in FIG. 3. The sliders 8a and 8b are displaceable here between an unlocking position—as is shown in FIG. 1—and a locking position—as is shown in FIG. 2. The securing element 9 is displaceable between a securing position—as is shown in FIG. 2—and a releasing position—as is shown in FIG. 1.

With reference to FIG. 2 the securing element 9 can be displaced from the releasing position into the securing position by a movement in tractive force direction ZR towards the first housing part 4a. The sliders 8a and 8b are displaced here oppositely in widthwise direction BR and are thereby brought from the unlocking position into the locking position. The movement directions of the sliders 8a and 8b and of the securing element 9 are indicated by arrows in FIG. 2. In the locking position, the slider 8a or respectively 8b is brought into engagement with a latch structure 11a or respectively 11b. For this, the latch structure 11a or respectively 11b has an undercut, into which the respective slider 8a or respectively 8b engages. The latch structure 11a or respectively 11b is formed on the first housing part 4a, such that in the locking position the battery stack 3 is secured on the first housing part 4a in a form-fitting manner and tractive forces are able to be transferred between the first housing part 4a and the battery cell stack 3 in tractive force direction ZR. As long as the securing element 9 is in the securing position, the sliders 8a and 8b cannot pass into the unlocking position and are secured in the latter. For example, the securing element 9 can be screwed to the first housing part 4a and can thereby be fixed in the securing position.

With reference to FIG. 1, the sliders 8a and 8b are displaced from the locking position into the unlocking position by return springs 12a and 12b. Here, the sliders 8a and 8b shifted oppositely in width-wise direction BR. However, this is only possible when the securing element 9 is displaced into the releasing position—therefore is brought away from the first housing part 4a in tractive force direction. The return springs 12a and 12b are received in the intermediate plate 10 and cooperate respectively with the sliders 8a and 8b. In the unlocking position, the slider 8a or respectively 8b is free of the respective latch structure 11a or respectively 11b and the battery cell stack 3 is released from the first housing part 4a.

As can be seen in FIG. 1 and FIG. 2, the securing element 9 can be displaced from the exterior out of the releasing position into the securing position, such that the two sliders 8a and 8b and the two latch structures 11a and 11b do not have to be accessible from the exterior. Thereby, the mounting and the dismantling of the battery module 1 or respectively of the battery cell stack 3 in the module housing 4 can be distinctly simplified. In this exemplary embodiment, the latch structure 11a and 11b is formed within the interior 6 opposite the open side of the first housing part 4a or respectively the open side of the housing upper shell or respectively the second housing part 4b. When the battery cell stack 3 is arranged in the first housing part 4a, the sliders 8a and 8b and the latch structures 11a and 11b are not accessible from the exterior. The securing element 9, on the other hand, is accessible from a side of the battery cell stack 3 facing away from latch structures 11a and 11b, or respectively from the open side of the first housing part 4a or respectively from the open side of the housing upper shell, and can actuate the respective sliders 8a and 8b.

FIG. 3 shows a view of the battery cell stack 3 of the battery module 1 from a side facing the second housing part 4b. As already mentioned above, the battery cell stack 3 has several battery cells 5, which are stacked adjacent to one another in stacking direction SR. At opposite stack ends 14a and 14b, clamping plates 15a or respectively 15b are arranged. The battery cells 5 are braced with one another in stacking direction SR by two clamping bands 13, wherein the clamping bands 13 rest onto the two clamping plates 15a and 15b. The intermediate plate 10 is arranged between two adjacent battery cells 5 approximately centrally in the battery cell stack 3. Furthermore, an opening 16 is visible here in the intermediate plate 10, through which the securing element 9 can be guided onto the opposite side of the battery cell stack 3 towards the first housing part 4a.

In FIG. 4, a view is shown of the battery cell stack 3 from a side facing the first housing part 4a. Here, the battery cell stack 3 is shown with the second housing part 4b. As already explained above, the battery cell stack 3 is glued with the second housing part 4b, such that the second housing part 4b together with the battery cell stack 3 can be mounted on the first housing part 4a. Here, on the second housing part 4b also mounting openings 17 for mounting screws are visible, through which the second housing part 4b can be screwed to the first housing part 4a.

In summary, the battery cell stack 3 is fixed in a form-fitting and detachable manner by the locking device 7 within the module housing 4 on the first housing part 4a. Furthermore, the second housing part 4b is glued with the battery cell stack 3. Thereby the module housing 4 is reinforced by the stable structure of the battery cell stack 3 and its stability is increased. In particular, thereby the unwanted bulging of the module housing 4 can be prevented and a mechanical damage to the module housing 4, occurring in an extreme case, can be effectively counteracted.

It is understood that the foregoing description is that of the exemplary embodiments of the disclosure and that various changes and modifications may be made thereto without departing from the spirit and scope of the disclosure as defined in the appended claims.

What is claimed is:

1. A battery module for a traction battery, in particular for a battery electric vehicle, the battery module comprising:
a battery cell stack; and
a module housing,
wherein the module housing has a first housing part and a second housing part and surrounds an interior, in which the battery cell stack is arranged,
wherein the battery cell stack is formed from several battery cells, which are arranged adjacent to one another in a stacking direction,
wherein the module housing in particular can be able to be flowed through directly by a coolant, in such a way that the battery cells in the interior come directly in contact with the coolant, and
wherein the battery module has a locking device, which secures the battery cell stack within the interior in a form-fitting manner at least to one of the housing parts, in particular to the first housing part.

2. The battery module according to claim 1, wherein:
the locking device has at least one slider, which is held within the battery cell stack,
the respective slider is displaceable between a locking position and an unlocking position, and
the respective slider in the locking position is in engagement with a latch structure formed on the one housing part, in particular on the first housing part, and in the unlocking position is free of the respective latch structure.

3. The battery module according to claim 2, wherein:
the respective slider is displaceable between the locking position and the unlocking position transversely to the stacking direction in a widthwise direction of the battery cell stack, and
the respective slider and the respective latch structure are able to be brought into engagement in such a way that tractive forces running transversely to the stacking direction in tractive force direction are able to be transferred between the one housing part, in particular the first housing part, and the battery cell stack.

4. The battery module according to claim 2, wherein the respective slider cooperates with a return spring, which drives the respective slider into the unlocking position.

5. The battery module according to claim 2, wherein:
the locking device has at least one securing element which is displaceable between a securing position and a releasing position, and
the respective securing element cooperates with at least one such slider in such a way that the respective slider moves through the securing element into the locking position, and is secured in the latter, when the respective securing element is displaced into its securing position.

6. The battery module according to claim 5, wherein:
the securing element is displaceable between the securing position and the releasing position transversely to the stacking direction in tractive force direction, and
the respective securing element cooperates with at least one such slider in such a way that the respective slider is displaceable transversely to the stacking direction in width-wise direction into the locking position.

7. The battery module according to claim 5, wherein the securing element is accessible from a side of the battery cell stack facing the second housing part, such that the slider, which is inaccessible from the exterior, is able to be actuated from the exterior.

8. The battery module according to claim 5, wherein the respective securing element in the securing position connects the first housing part transversely to the stacking direction in tractive force direction with the second housing part.

9. The battery module according to claim 8, wherein:
the securing element is a tie rod with a head and with a shaft, and
the head rests on an outer side of the second housing part facing away from the first housing part and the shaft engages into the first housing part in a form-fitting manner, penetrating the interior.

10. The battery module according to claim 5, wherein:
for locking the battery cell stack with the one housing part, in particular with the first housing part, two such sliders and one such securing element are provided,
the two sliders move oppositely in widthwise direction and the securing element moves in tractive force direction, and
the two sliders cooperate with the same securing element and are displaced into their respective locking position and are secured in the latter when the securing element is displaced into the securing position.

11. The battery module according to claim 1, wherein:
the battery module has at least one intermediate plate, which is arranged in the battery cell stack between two adjacent battery cells, and
the locking device is held at least partially in this intermediate plate.

12. The battery module according to claim 2, wherein the respective slider is received in the intermediate plate and is displaceable within the latter transversely to the stacking direction in widthwise direction.

13. The battery module according to claim 1, wherein:
the battery cell stack within the interior is secured in a form-fitting manner with the locking device on the first housing part and on the second housing part, or
the battery cell stack within the interior is secured in a form-fitting manner with the locking device on the first housing part and is undetachably connected with the second housing part, or
the battery cell stack within the interior is secured in a form-fitting manner with the locking device only on the second housing part.

14. A traction battery for a battery electric vehicle, wherein the traction battery has at least one battery module according to claim 1.

15. The traction battery according to claim 14, wherein:
the traction battery has a single battery module, such that the battery module represents the traction battery, or
the traction battery has several battery modules, wherein the respective module housings of the battery modules are represented by a shared battery housing of the traction battery, or
the traction battery has several battery modules, wherein the battery modules are accommodated with their module housings in a shared battery housing.
